(19) United States
(12) Patent Application Publication
(10) Pub. No.: US 2007/0228968 A1
(43) Pub. Date: Oct. 4, 2007

(54) Plasma display panel and flat panel display device including the same

(76) Inventors: Hyun Soh, Suwon-si (KR); Se-Jong Kim, Suwon-si (KR); Yun-Hee Kim, Suwon-si (KR); Hyun Kim, Suwon-si (KR)

Correspondence Address: KNOBBE MARTENS OLSON & BEAR LLP, 2040 MAIN STREET, FOURTEENTH FLOOR, IRVINE, CA, 92614, US

(21) Appl. No.: 11/729,329

(22) Filed: Mar. 27, 2007

(30) Foreign Application Priority Data
Mar. 30, 2006 (KR) 10-2006-0029115

(51) Int. Cl. H01J 17/49

(52) U.S. Cl. 313/582

(57) ABSTRACT

Provided is a plasma display panel including a first substrate and a second substrate facing each other, barrier ribs disposed between the first and second substrates and defining a plurality of discharge cells, a pair of sustain electrodes spaced apart from each other on the first substrate facing the second substrate, and each comprising an X electrode and an Y electrode, phosphor substances emitting red, green, and blue light, each color of light formed in the plurality of discharge cells, and a first dielectric layer covering the pair of sustain electrodes and comprising at least two corresponding grooves at each discharge cell, wherein an interval between the X electrode and the Y electrode is larger than the height of the barrier ribs, and an interval between the grooves in the discharge cell comprising the phosphor substance emitting light of one color is different from an interval between the grooves in another discharge cell comprising the phosphor substance emitting light of another color.

### CROSS-REFERENCE TO RELATED PATENT APPLICATION

This application claims the benefit of Korean Patent Application No. 10-2006-0029115, filed on Mar. 30, 2006, in the Korean Intellectual Property Office, the disclosure of which is incorporated herein in its entirety by reference.

### BACKGROUND OF THE INVENTION

1. Field of the Invention

The present embodiments relate to a plasma display panel and a flat panel display, and more particularly, to a plasma display panel having an improved light emitting efficiency.

2. Description of the Related Art

Plasma display devices including a plasma display panels have come into the spotlight as large flat panel display devices. The plasma display device displays an image using visible rays which are generated while vacuum ultraviolet (VUV) radiation, generated by encapsulating discharge gas between two substrates of the plasma display panel including a plurality of electrodes and applying a discharge voltage, excites a phosphor substance formed according to a predetermined pattern.

FIG. 1 is an exploded perspective view of a three-electrode surface discharge AC plasma display panel 100.

The plasma display panel 100 of FIG. 1 includes a first panel and a second panel. The first panel includes a first substrate 102, an X electrode 112 (a common electrode) including a transparent electrode 112a and a bus electrode 112b, a Y electrode 114 (an address electrode) including a transparent electrode 114a and a bus electrode 114b, a first dielectric layer 109a, a protective film 110, etc. The second panel includes a second substrate 104, an address electrode 116, a second dielectric layer 109b, barrier ribs 106, a phosphoric layer 108, etc. The first substrate 102 and the second substrate 104 face each other in parallel while being spaced apart from each other. A space between the first and second electrodes 102 and 104 forms discharge cells as unit discharge spaces, which generate discharges, wherein the discharge cells are defined by barrier ribs 106.

FIG. 2 is a cross-sectional view of a structure of a discharge cell 120B in the plasma display panel illustrated in FIG. 1, as seen from an X-Z plane direction.

When a driving voltage is applied to a discharge space inside the discharge cell 120B through the first and second electrodes 112 and 114, VUV is generated by plasma discharge, based on the driving voltage. The VUV excites the phosphor layer 108 in order to emit visible rays and then the emitted visible rays penetrate the first panel and thus provide visual stimulus to a viewer of the plasma display panel 100.

However, the plasma display panel 100 has a high driving voltage and a low light emitting efficiency.

Accordingly, an increase in light emitting efficiency and a decrease in discharge voltage are required. The present embodiments provide, for example, a plasma display panel which can operate below a predetermined discharge voltage and which has a high light emitting efficiency.

### SUMMARY OF THE INVENTION

The present embodiments provide a plasma display panel which has a low driving voltage and improved light emitting efficiency.

The present embodiments also provide a flat panel display including the plasma display panel having low driving voltage and improved light emitting efficiency.

According to an aspect of the present embodiments, there is provided a plasma display panel including: a first substrate and a second substrate facing each other; barrier ribs disposed between the first and second substrates and defining a plurality of discharge cells; a pair of sustain electrodes spaced apart from each other on the first substrate facing the second substrate, and each comprising an X electrode and an Y electrode; phosphor substances emitting red, green, and blue light, each color of light formed in the plurality of discharge cells; and a first dielectric layer covering the pair of sustain electrodes and comprising at least two corresponding grooves at each discharge cell, wherein an interval between the X electrode and the Y electrode is larger than the height of the barrier ribs, and an interval between the grooves in the discharge cell comprising the phosphor substance emitting light of one color is different from an interval between the grooves in another discharge cell comprising the phosphor substance emitting light of another color.

An interval between the grooves in the discharge cell including the phosphor substance emitting blue light may be larger than an interval between the grooves in the discharge cell comprising the phosphor substance emitting red or green light.

The grooves may be formed corresponding to the X electrodes and the Y electrodes.

Two grooves may be formed in each discharge cell, wherein the two grooves are each formed corresponding to the X electrode and the Y electrode.

An interval between the two grooves may be larger than an interval between the X electrode and the Y electrode and smaller than a distance between an exterior end part of the X electrode and an exterior end part of the Y electrode.

The grooves, formed corresponding to one discharge cell, may be disposed so as to be symmetrical to a virtual reflecting surface formed between the X and Y electrodes of one pair of sustain electrodes.

The grooves may be formed discontinuously at each of the discharge cells.

An interval between the grooves in the discharge cell including the phosphor substance emitting blue light may be approximately 250 μm or less.

The X electrode and the Y electrode may each include a bus electrode and a transparent electrode formed on the bus electrode, wherein at least a part of the bus electrode is disposed corresponding to the barrier rib.

The X electrode and the Y electrode may each include a bus electrode and a transparent electrode formed on the bus electrode, wherein the bus electrodes are spaced apart from each other at predetermined intervals from the barrier ribs towards the central direction of the discharge cells.

The first dielectric layer may include a Bi series. Preferably, the first dielectric layer may include Bi₂O₃. More preferably, the first dielectric layer may include a mixture of Bi₂O₃, B₂O₃, and ZnO.

The plasma display panel may further include: an address electrode disposed so as to cross the pair of sustain electrodes, on the second substrate facing the first substrate; and a second dielectric layer covering the address electrode.

According to another aspect of the present embodiments, there is provided a flat panel display device including the plasma display panel described above.

### BRIEF DESCRIPTION OF THE DRAWINGS

The above and other features and advantages of the present embodiments will become more apparent by describing in detail exemplary embodiments thereof with reference to the attached drawings in which:

FIG. 1 is an exploded perspective view of a conventional three-electrode surface discharge AC plasma display panel;

FIG. 2 is a cross-sectional view of a structure of a discharge cell in the conventional plasma display panel illustrated in FIG. 1, as seen from an X-Z plane direction;

FIG. 3 is an exploded perspective view of a plasma display panel including a groove according to an embodiment;

FIG. 4 is a cross-sectional view of a structure of a discharge cell in the plasma display panel illustrated in FIG. 3, as seen from an X-Z plane direction;

FIG. 5 is a cross-sectional view of an upper plate from the cross-sectional view of the plasma display panel illustrated in FIG. 4; and

FIG. 6 is a transparent view of a part of discharge cells of the plasma display panel illustrated in FIG. 3, as seen from a Z direction.

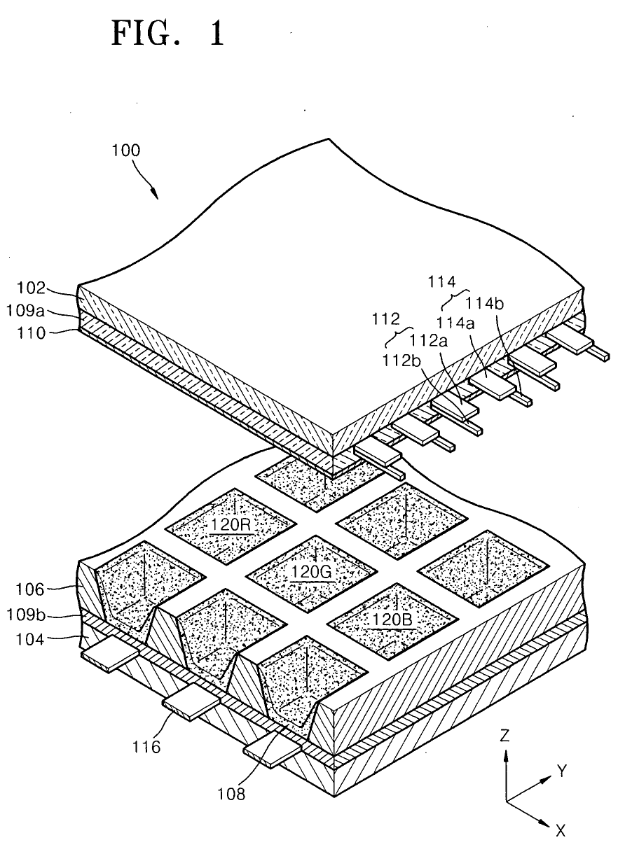

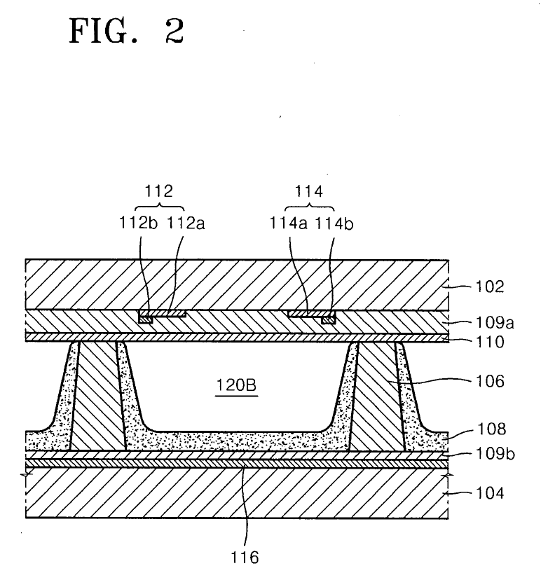

### DETAILED DESCRIPTION OF THE INVENTION

Hereinafter, the present embodiments will be described more fully with reference to the accompanying drawings, in which exemplary embodiments are shown.

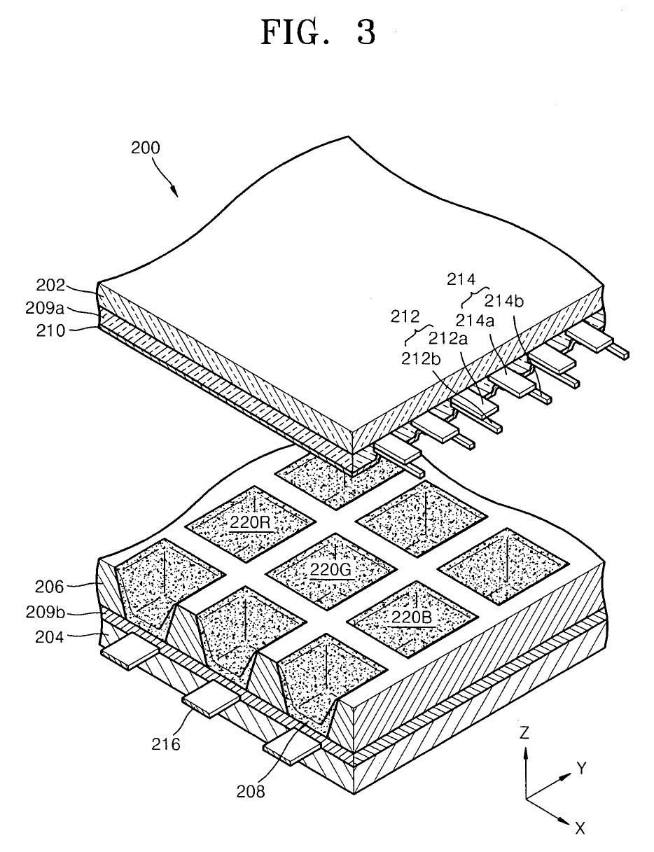

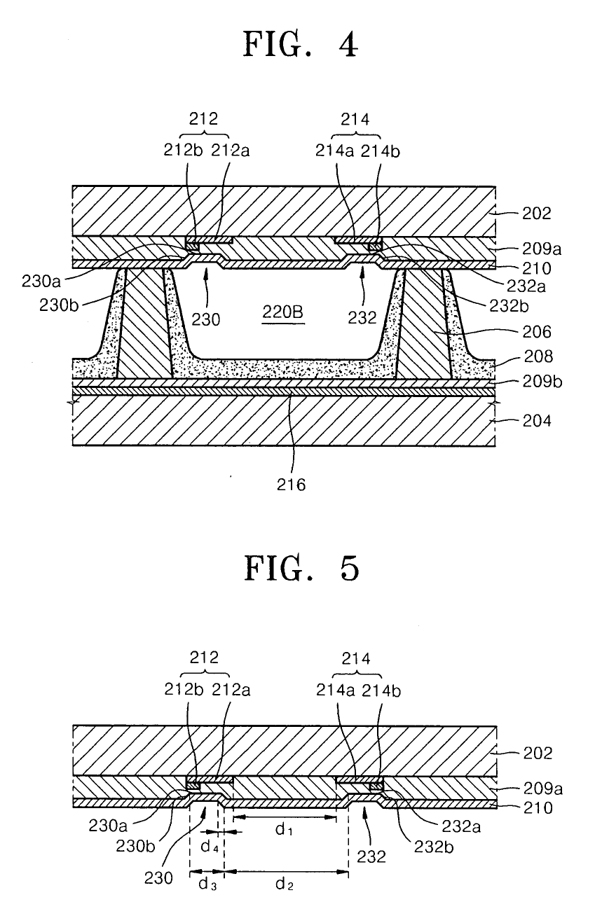

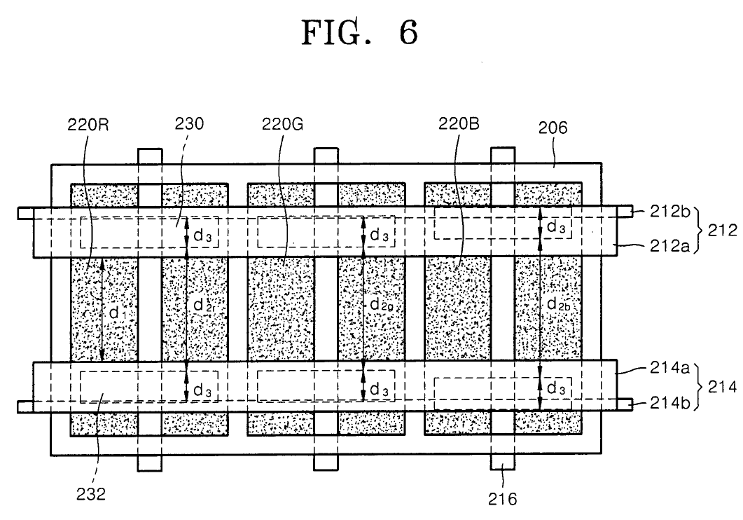

FIG. 3 is an exploded perspective view of a plasma display panel 200 including grooves according to one embodiment, FIG. 4 is a cross-sectional view of the structure of a discharge cell 220B in the plasma display panel illustrated in FIG. 3, as seen from an X-Z plane direction, FIG. 5 is a cross-sectional view of an upper plate from the cross-sectional view of the plasma display panel illustrated in FIG. 4, and FIG. 6 is a transparent view of the plasma display panel 200 illustrated in FIG. 3, as seen from a Z direction in order to show sustain electrodes 212 and 214, discharge cells 220R, 220G, and 220B, and grooves 230 and 232 illustrated in FIG. 3.

Referring to FIG. 3, the plasma display panel 200 includes an upper plate and a lower plate combined parallel to the upper plate. The upper plate includes a first substrate 202, a first dielectric layer 209a, a pair of sustain electrodes 212 and 214, and a protective layer 210. The lower plate includes a second substrate 204, address electrodes 216, a second dielectric layer 209b, barrier ribs 206, and phosphor layers 208.

The first substrate 202 and the second substrate 204 are spaced apart from each other by a predetermined interval and define discharge spaces between them which generate discharge. The first and second substrates 202 and 204 may be formed of, for example glass, or any material having excellent visible ray transmission rate. However, for good bright room contrast, the first substrate 202 and/or the second substrate 204 may be colored.

The barrier ribs 206 are disposed between the first substrate 202 and the second substrate 204. The barrier ribs 206 are disposed on the second dielectric layer 209b. The barrier ribs 206 define the discharge spaces with a plurality of discharge cells 220R, 220G, and 220B and prevent optical/electrical cross-talk between the plurality of discharge cells 220R, 220G, and 220B.

Referring to FIG. 3, the barrier ribs 206 define the discharge cells 220R, 220G, and 220B having tetragonal cross-sections. Accordingly, the barrier ribs 206 have a closed type structure. However, the present embodiments are not limited thereto, and the barrier ribs 206 may have a closed type structure whereby the discharge cells 220R, 220G, and 220B have polygonal cross-sections, such as triangular cross-sections, pentagonal cross-sections, etc., circular cross-sections, oval cross-sections, or the like, or may have an opened type structure so that the discharge cells 220R, 220G, and 220B have striped cross-sections, or the like. Also, the barrier ribs 206 may define the discharge cells 220R, 220G, and 220B in a waffle or delta arrangement.

The pair of sustain electrodes 212 and 214 are disposed on the first substrate 202 facing the second substrate 204. Each pair of sustain electrodes 212 and 214 denotes one pair of sustain electrodes 212 and 214 formed on the back of the first substrate 202 in order to generate a sustain discharge. The pair of sustain electrodes 212 and 214 are disposed parallel to each other at predetermined intervals on the first substrate 202.

One sustain electrode from the pair of sustain electrodes 212 and 214 is an X electrode 212 which functions as a common electrode, and the other sustain electrode is an Y electrode 214 which functions as an address electrode. According to an embodiment, the pair of sustain electrodes 212 and 214 are disposed directly on the first substrate 202, but the disposing location of the pair of sustain electrodes 212 and 214 is not limited thereto. For example, the pair of sustain electrodes 212 and 214 may be spaced apart from each other at predetermined intervals from the first substrate 202 to the second substrate 204.

Considering the above, in order to increase light emitting efficiency by using a long gap, the interval d1 illustrated in FIG. 5 of the X electrode 212 and the Y electrode 214 according to an embodiment is formed to be larger than the height of the barrier ribs 206. The interval d1 of the X electrode 212 and the Y electrode 214 may be from about 110 μm to about 260 μm in order to prevent a driving voltage from increasing to a predetermined voltage or higher, for example, approximately 300 V or higher.

Referring to FIG. 3, the X electrode 212 includes a transparent electrode 212a and a bus electrode 212b, and the Y electrode 214 includes a transparent electrode 214a and a bus electrode 214b. The transparent electrodes 212a and 214a are formed of a transparent material, which is a conductor that can generate a discharge and which does not substantially interfere with light emitted from the phosphor layers 208, proceeding to the first substrate 202. Such a transparent material can include, for example, indium tin oxide (ITO), or the like. However, when using transparent electrodes 212a and 214a formed of ITO, a high driving voltage is required and the response speed is slow, because of a large voltage drop in a longitudinal direction. The transparent electrodes 212a and 214a have a predetermined width d3 as illustrated in FIG. 5.

The bus electrodes 212b and 214b, formed of metal and having a narrow width, are disposed on the transparent electrodes 212a and 214a. The bus electrodes 212b and 214b can be formed to have a mono-layered structure using a metal such as, for example, Ag, Al or Cu, but can also be formed to have a multi-layered structure. The transparent electrodes 212a and 214b and the bus electrodes 212b and 214b are formed using, for example, photo etching, photolithography, or the like.

As described above, each of the bus electrodes 212b and 214b are electrically connected to the transparent electrodes 212a and 214a. The rectangular shaped transparent electrodes 212a and 214a can be continuously disposed while penetrating each discharge cell 220R, 220G, and 220B respectively emitting red, green and blue light, or can be discontinuously disposed at each discharge cell 220R, 220G, and 220B. Part of the transparent electrodes 212a and 214a is connected to the bus electrodes 212b and 214b, while the other part is disposed toward the center of the discharge cells 220R, 220G, and 220B. However, the transparent electrodes 212a and 214a may have various forms.

Referring to FIGS. 3 and 4, the first dielectric layer 209a is formed on the first substrate 202 while covering the pair of sustain electrodes 212 and 214. The first dielectric layer 209a prevents the adjacent X electrodes 212 and Y electrodes 214 from conducting with each other, and at the same time, prevents charged particles or electrons from directly colliding with the X electrodes 212 and the Y electrodes 214, thereby damaging the X electrodes 212 and the Y electrodes 214. Also, the first dielectric layer 209a induces an electric charge.

Referring to FIGS. 4 and 5, first grooves 230 and second grooves 232 are formed on the first dielectric layer 209a. The first grooves 230 and the second grooves 232 are formed to a predetermined depth on the first dielectric layer 209a. The depth of the first and second grooves 230 and 232 is determined based on the possibility of damage to the first dielectric layer 209a caused by a plasma discharge, a wall charge arrangement, the size of a discharge voltage, etc.

One first groove 230 and one second groove 232 are formed corresponding to each other at each of the discharge cells 220R, 220G, and 220B each respectively formed of red, green, blue phosphor substances. The thickness of the first dielectric layer 209a is decreased by the first and second grooves 230 and 232, thereby increasing a visible ray transmission rate toward the front. According to some embodiments, the first grooves 230 and the second grooves 232 are substantially formed to have cross sections of a concave portion including floors 230a or 232a of the first and second grooves 230 and 232, and sides 230b or 232b of the first and second grooves 230 and 232, but are not limited thereto and may have various forms. Here, sides 230b and 232b of the first and second grooves 230 and 232 are formed to a predetermined width d4 as illustrated in FIG. 5.

Also, the first grooves 230 and the second grooves 232 may be disposed symmetrically based on the center between the X electrodes 212 and the Y electrodes 214.

The first grooves 230 may be formed corresponding only to the transparent electrode 212a, formed corresponding only to a part of the bus electrode 212b, or formed in an area not corresponding to the X electrode 212. Also, the second grooves 232 can be formed in various locations.

The first grooves 230 and the second grooves 232 can be formed using various methods. For example, the first and second grooves 230 and 232 can be formed by applying a dielectric material on the first substrate 202 and then etching the first substrate 202. Such a method can be performed using a simple process and has low costs. However, the dielectric material usually used in a plasma display panel is a PbO—B₂O₃—SiO₂ (lead borosilicate) compound containing a Pb series. The dielectric material contains an appropriate level or more of a SiO₂ element in order to control an electric constant, thermal expansion coefficient, and reactivity with the bus electrodes 212b and 214b. However, Pb, is harmful to the human body. Accordingly, the first dielectric layer 209a is formed containing a Bi series, and the Bi series may include Bi₂O₃. Preferably, the first dielectric layer 209a may be formed including Bi₂O₃—B₂O₃—ZnO.

The first dielectric layer 209a is covered by the protective layer 210. The protective layer 210 prevents charged particles and electrons from colliding with the first dielectric layer 209a during discharge and damaging the first dielectric layer 209a. Also, the protective layer 210 emits many second electrons during the discharge thereby smoothing a plasma discharge. Such a protective layer 210 is formed using a material having a high second electron emission coefficient and a high visible ray transmission rate. The protective layer 210 is formed in a thin layer using, for example, sputtering and electron-beam evaporation, after the first dielectric layer 209a is formed.

Address electrodes 216 are formed on the second substrate 204 facing the first substrate 202. The address electrodes 216 extend across the discharge cells 220R, 220G, and 220B in order to cross the X electrodes 212 and the Y electrodes 214.

The address electrodes 216 are used in order to generate an address discharge for easier sustain discharge between the X and Y electrodes 212 and 214. The address electrodes 216 decrease the voltage for generating the sustain discharge. The address discharge is a discharge generated between the Y electrode 214 and the address electrode 214.

The second dielectric layer 209b is formed on the second substrate 204 while covering the address electrodes 216. The second dielectric layer 209b is formed of a dielectric material which can prevent charged particles or electrons from colliding with the address electrodes 216 during discharge and damaging the address electrodes 216, and which can induce an electric charge. Such a dielectric material may comprise a Bi₂O₃—B₂O₃—ZnO compound.

The phosphor layers 208 emitting red, green, and blue light are disposed on both sides of the barrier ribs 206 formed on the second dielectric layer 209 and in front of the second dielectric layer 209b where the barrier ribs 206 are not formed. The phosphor layers 208 contain an element generating visible rays by receiving ultraviolet rays. The phosphor layer 208, disposed on the discharge cell 220R emitting red light, includes a phosphor substance, such as Y(V,P)O₄:Eu, or the like. The phosphor layer 208, disposed on the discharge cell 220G emitting green light, includes a phosphor substance, such as Zn₂SiO₄:Mn, YBO₃:Tb, or the like. The phosphor layer 208, disposed on the discharge cell 220B emitting blue light, includes a phosphor substance, such as BAM:Eu, or the like.

Also, discharge gas, mixed with, for example, neon (Ne), xenon (Xe), and the like, is filled inside the discharge cells 220R, 220G, and 220B. While the discharge cells 220R, 220G, and 220B are filled with the discharge gas, the first substrate 202 and the second substrate 204 are sealed and combined using a sealing member, such as frit glass formed on the edge of the first and second substrates 202 and 204.

Referring to FIG. 5, a relationship between the interval between the first and second grooves 230 and 232, and an interval between the X and Y electrodes 212 and 214 is illustrated.

As described above, phosphor layers 208, each emitting red, green, and blue light, are formed in the plurality of discharge cells 220R, 220G, and 220B. Accordingly, each of the discharge cells 220R, 220G, and 220B respectively emits red, green, and blue light, based on the type of phosphor layers 208 formed inside.

However, when grooves are formed on dielectric layers of a fixed size without considering light emitting properties of phosphor substances inside each discharge cell, the luminance of a panel is not regular. Table 1 shows a luminance ratio (brightness ratio) of phosphor substances emitting light of different colors.

TABLE 1

| | Phosphor | | |
|---|---|---|---|
| Type of | substance | | |
| phosphor | emitting | Phosphor substance | Phosphor substance |
| substances | red light | emitting green light | emitting blue light |
| Luminance | 27% | 62% | 11% |
| Ratio | | | |

As shown in Table 1, luminance properties of each discharge cell are not the same in the light emission of the actual phosphor substances. Generally, the luminance of the phosphor substance emitting blue light is lower than the phosphor substances emitting light of other colors.

In order to solve the above problem, in a plasma display panel according to some embodiments, an interval d2 between the first and second grooves 230 and 232 inside the discharge cell emitting red, blue, or green light is formed so as to be larger than an interval between the first and second grooves 230 and 232 inside the discharge cells emitting the other light of the remaining colors.

In this embodiment, the interval d2 between the first and second grooves 230 and 232 inside the discharge cells 220R, 220G, 220B emitting red, green and blue light is larger than the interval d1 between the sustain electrodes 212 and 214.

As shown in FIG. 6, since the luminance of a phosphor layer emitting blue light is low, an interval d2b between grooves 230 and 232 formed inside a discharge cell 220B emitting blue light is larger than an interval d2r between grooves 230 and 232 formed inside a discharge cell 220R emitting red light and an interval d2g between grooves 230 and 232 formed inside a discharge cell 220G emitting green light. The interval d2b between the grooves 230 and 232 inside the discharge cell 220B, including a phosphor substance emitting blue light, may be about 250 μm or below.

Meanwhile, the grooves 230 and 232 are formed corresponding to the X electrodes 212 and the Y electrodes 214. Here, the interval d2b, d2r, or d2g between the grooves 230 and 232 inside one discharge cell 220B, 220R, or 220G respectively is larger than an interval between the X electrode 212 and the Y electrode 214, and is smaller than a distance between an exterior end part of the X electrode 212 and an exterior end part of the Y electrode 214.

As described above, when the interval d2b between the grooves 230 and 232 inside the discharge cell 220B emitting blue light is larger than the intervals d2g and d2r between the grooves 230 and 232 inside the discharge cells 220G and 220R, respectively, luminance ratio of the discharge cell 220B increases, thereby increasing the overall color temperature. Thus, the light emitting efficiency of a panel increases.

Table 2 confirms that a light emitting efficiency increases by improving a luminance ratio and increasing a color temperature.

TABLE 2

| | | Phosphor substance | Phosphor substance | Phosphor substance |
|---|---|---|---|---|
| Phosphor Substance | | emitting red light | emitting green light | emitting blue light |
| Luminance Ratio | Without | 27% | 62% | 11% |
| | Increase | | | |
| | in Blue | | | |
| | discharge | | | |
| | cell | | | |
| | With | 24% | 61% | 15% |
| | Increase | | | |
| | in Blue | | | |
| | discharge | | | |
| | cell | | | |

| | | |
|---|---|---|
| Color | Without | 100% |
| Temperature | Increase | |
| | in Blue | |
| | discharge | |
| | cell | |
| | With | 109% |
| | Increase | |
| | in Blue | |
| | discharge | |
| | cell | |
| Light Emitting | Without | 100% |
| Efficiency | Increase | |
| | in Blue | |
| | discharge | |
| | cell | |
| | With | 107% |
| | Increase | |
| | in Blue | |
| | discharge | |
| | cell | |

The luminance ratio of Table 2 is the luminance ratio between pixels obtained by increasing the size of a dielectric pattern inside a discharge cell including a phosphor substance emitting blue light in a 42 inch panel. As shown in Table 2, by increasing an interval between the discharge cell emitting blue light so as to be larger than intervals between discharge cells emitting other colors, the luminance ratio increases. The increase in the luminance ratio increases the color temperature of the panel, and the increase of the overall luminance improves the light emitting efficiency of the panel.

Hereinafter, operations of the plasma display panel 200 illustrated in FIG. 3 will be described.

A plasma discharge generated in the plasma display panel 200 can be classified into an address discharge or a sustain discharge. The address discharge is generated by applying an address discharge voltage between the address electrode 216 and the Y electrode 214. As a result of the address discharge, the discharge cells 220R, 220G, and 220B, in which the sustain discharge are to be generated, is selected.

Next, the sustain discharge is applied between the X and Y electrodes 212 and 214 of the selected discharge cell. An electric field is focused on the first and second grooves 230 and 232, formed on the first dielectric layer 209a, thereby decreasing a discharge voltage. This is because a discharge path between the X and Y electrodes 212 and 214 decreases, and the electric field is focused on the discharge path. Accordingly, the density of an electric charge, charged particles, excited species, and the like is high.

During the sustain discharge, the energy level of exited discharge gas decreases, and thus ultraviolet rays are emitted. The emitted ultraviolet rays excite the phosphoric layers 208 coated inside the discharge cells 220B, 220R, and 220G. The energy level of the excited phosphoric layers 208 decreases in order to emit visible rays. The emitted visible rays penetrate the first dielectric layer 209a and the first substrate 202 in order to form an image which can be recognized by a user.

As described above, by improving an unbalanced luminance ratio of discharge cells emitting red, green, and blue light, luminance ratio and color temperature increase. Accordingly, overall efficiencies of a plasma display panel according to the present embodiments increase.

While the present embodiments have been particularly shown and described with reference to exemplary embodiments thereof, it will be understood by those of ordinary skill in the art that various changes in form and details may be made therein without departing from the spirit and scope of the present embodiments as defined by the following claims.

What is claimed is:

1. A plasma display panel comprising:
a first substrate and a second substrate facing each other;
barrier ribs disposed between the first and second substrates and defining a plurality of discharge cells;
a pair of sustain electrodes spaced apart from each other on the first substrate facing the second substrate, and each comprising an X electrode and a Y electrode;
phosphor substances configured to emit red, green, and blue light, formed in the plurality of discharge cells; and
a first dielectric layer covering the pair of sustain electrodes and comprising at least two corresponding grooves at each discharge cell,
wherein the interval between the X electrode and the Y electrode is larger than the height of the barrier ribs, and
the interval between the grooves in the discharge cell comprising the phosphor substance emitting light of one color is different from an interval between the grooves in another discharge cell comprising the phosphor substance emitting light of another color.

2. The plasma display panel of claim 1, wherein an interval between the grooves in the discharge cell comprising the phosphor substance emitting blue light is larger than an interval between the grooves in the discharge cell comprising the phosphor substance emitting red or green light.

3. The plasma display panel of claim 1, wherein the grooves are formed corresponding to the X electrodes and the Y electrodes.

4. The plasma display panel of claim 2, wherein two grooves are formed in each discharge cell, wherein the two grooves are each formed corresponding to the X electrode and the Y electrode.

5. The plasma display panel of claim 4, wherein the interval between the two grooves is larger than the interval between the X electrode and the Y electrode and smaller than the distance between an exterior end part of the X electrode and an exterior end part of the Y electrode.

6. The plasma display panel of claim 1, wherein the grooves, formed corresponding to one discharge cell, are disposed so as to be symmetrical to a virtual reflecting surface formed between the X and Y electrodes of one pair of sustain electrodes.

7. The plasma display panel of claim 1, wherein the grooves are formed discontinuously at each of the discharge cells.

8. The plasma display panel of claim 2, wherein the interval between the grooves in the discharge cell comprising the phosphor substance emitting blue light is about 250 μm or less.

9. The plasma display panel of claim 1, wherein the X electrode and the Y electrode each comprise a bus electrode and a transparent electrode formed on the bus electrode, wherein at least a part of the bus electrode is disposed corresponding to the barrier ribs.

10. The plasma display panel of claim 1, wherein the X electrode and the Y electrode each comprise a bus electrode and a transparent electrode formed on the bus electrode, wherein the bus electrodes are spaced apart from each other at predetermined intervals from the barrier ribs towards the central direction of the discharge cells.

11. The plasma display panel of claim 1, wherein the first dielectric layer comprises a Bi series.

12. The plasma display panel of claim 11, wherein the first dielectric layer comprises Bi₂O₃.

13. The plasma display panel of claim 12, wherein the first dielectric layer comprises Bi₂O₃, B₂O₃, and ZnO.

14. The plasma display panel of claim 1, further comprising:
an address electrode disposed so as to cross the pair of sustain electrodes, on the second substrate facing the first substrate; and
a second dielectric layer covering the address electrode.

15. A flat panel display device comprising the plasma display panel of claim 1.

16. A flat panel display device comprising the plasma display panel of claim 14.
